(19) United States
(12) Patent Application Publication
(10) Pub. No.: US 2011/0157506 A1
(43) Pub. Date: Jun. 30, 2011

(54) ELECTRO-OPTICAL DEVICE AND ELECTRONIC APPARATUS

(75) Inventor: Yoshikazu Eguchi, Fujimi-machi (JP)

(73) Assignee: Seiko Epson Corporation, Tokyo (JP)

(21) Appl. No.: 12/969,805

(22) Filed: Dec. 16, 2010

(30) Foreign Application Priority Data
Dec. 24, 2009 (JP) 2009-291949

(51) Int. Cl. G02F 1/1343

(52) U.S. Cl. 349/39

(57) ABSTRACT

Scanning lines and capacitive lines or data lines and the capacitive lines are partially overlapped between reflective electrodes.

Japanese Patent Application No. 2009-291949, filed Dec. 24, 2009 is incorporated by reference in its entirety herein.

### BACKGROUND

1. Technical Field

The present invention relates to an electro-optical device and an electronic apparatus including the electro-optical device.

2. Related Art

A reflective type liquid crystal device (display device) which is an example of an electro-optical device may display an image having higher light use efficiency and lower grating sense than in the case of a transmissive type liquid crystal device in the configuration thereof and thus has been widely used as light modulation means (light valve) of a projector.

A general reflective type display device has a lamination configuration in which a circuit layer including circuit elements such as switching transistors for scanning and driving pixels, a wiring line layer of scanning lines, data lines and the like, and a reflective electrode layer in which a plurality of reflective electrodes is arranged in a matrix in this order are laminated on a silicon substrate (a device substrate). In addition, some of the circuit elements are also formed between neighboring reflective electrodes.

A counter substrate facing the silicon substrate is included, and transmittance of a liquid crystal layer interposed between the plurality of reflective electrodes and a transparent common electrode formed on the counter substrate is adjusted to perform a display. In detail, among light incident from the counter substrate, light transmitted according to the transmittance is reflected from the reflective electrodes, thereby performing a display.

In such a display device, among light incident from the counter substrate, a problem occurs in processing of light incident between the reflective electrodes. In detail, when light incident between the reflective electrodes is repeatedly refracted or reflected so as to reach the circuit layer, malfunction of a transistor is caused by the light (stray light).

In order to solve this problem, a technology of providing a light absorption layer including metal having a light absorption function on a lower layer of a space between the reflective electrodes in the lamination structure on the silicon substrate and absorbing light incident between the reflective electrodes has been known.

However, in this technology, the lamination structure becomes complicated. In addition, if the light absorption layer cannot fully absorb the light incident between the reflective electrodes, stray light may reach the silicon substrate. Since the silicon substrate has high reflectivity in a visible light region, stray light may reflect from the substrate so as to cause malfunction of the transistor.

In consideration of such a problem, the present inventors proposed the configuration of JP-A-2008-102392. In detail, a device substrate includes a transparent substrate and circuit elements are arranged on a lower layer of reflective electrodes so as to cover the circuit elements with the reflective electrodes. In addition, a light absorber is adhered to a rear surface of the device substrate.

By this configuration, since light incident between the reflective electrodes transmits the transparent device substrate and is absorbed into the light absorber, it is possible to suppress the generation of stray light is suppressed and thus to prevent malfunction.

However, in the configuration of JP-A-2008-102392, although malfunction due to stray light is suppressed, it is difficult to obtain sufficient contrast.

In detail, as shown in FIG. 8 showing the plane configuration of JP-A-2008-102392, one data line 6 is interposed between reflective electrodes 9 (interval D) neighboring in a vertical direction (Y axis direction) and two wiring lines, namely, a scanning line 11 and a capacitive line 77 are interposed between the reflective electrodes 9 neighboring in a horizontal direction (X axis direction). That is, since two wiring lines are disposed respectively in the interval D between the left and the right in the horizontal direction, a ratio (area) occupied by the wiring lines is greater than in the case of the interval D in the vertical direction.

Since light reflected from such wiring lines (dot-hatched portions) is disposed in the interval of display light reflected from the reflective electrodes 9, display contrast deteriorates.

In particular, in the usage for the light valve requiring a small size and high precision, the size of the reflective electrodes 9 is reduced. However, since there is a limitation in balance with wiring line resistance and wiring line miniaturization, the size of the reflective electrodes 9 becomes a level which cannot ignore the ratio of the wiring line occupying the interval D, thereby causing contrast deterioration.

In the display device of the related art, the display device may deteriorate through overheating. This is because high-luminance light of a discharge type lamp or the like is irradiated to a small-sized display device such that light which cannot be fully reflected is converted into heat so as to heat the display device.

In particular, among lights incident between the reflective electrodes, light reaching the light absorber formed on the rear surface of the device substrate is substantially mostly converted into heat so as to heat the light absorber and the whole display device adhered to the light absorber.

### SUMMARY

An advantage of some aspects of the invention is that it is possible to realize the following application aspects.

### Application Aspects

According to an aspect of the invention, there is provided an electro-optical device including at least a transparent substrate; a plurality of scanning lines formed on the transparent substrate; a plurality of data lines crossing the scanning lines; a plurality of capacitive lines formed along an extension direction of the plurality of scanning lines or the plurality of data lines; and reflective electrodes disposed at intersections, in which the scanning lines and the data lines cross, on a higher layer of the plurality of scanning lines, the plurality of data lines and the plurality of capacitive lines, wherein the scanning lines and the capacitive lines or the data lines and the capacitive lines are partially overlapped between the neighboring reflective electrodes.

According to this electro-optical device, since the scanning lines and the capacitive lines or the data lines and the capacitive lines are partially overlapped between the reflective electrodes, it is possible to reduce a ratio occupied by the wiring line between the reflective electrodes by the overlapping portion of two wiring lines, compared with the display device of the related art.

Accordingly, since the quantity of light reflected between the reflective electrodes by the wiring line is reduced, it is possible to increase the display contrast compared with the display device of the related art and to obtain the desired display contrast.

Accordingly, it is possible to provide an electro-optical device capable of obtaining sufficient contrast.

In addition, any one wiring line of two wiring lines of the scanning lines and the capacitive lines or the data lines and the capacitive lines may be disposed on the reflective electrode side, and the other wiring line may be disposed on the lower layer side of one wiring line and may be covered with one wiring line.

In addition, the wiring line may be formed such that the wiring line width between the reflective electrodes is narrower than the wiring line width of a region overlapping the reflective electrodes.

In addition, the transparent substrate may be a quartz substrate or a sapphire substrate.

In addition, the electro-optical device may further include a light absorber configured to absorb light passing between the reflective electrodes at a side opposed to the reflective electrodes of the transparent substrate, and the light absorber may be disposed so as to be separated from the transparent substrate.

An anti-reflection film may be formed on a surface of the wiring line exposed between the reflective electrodes.

The anti-reflection film may be included titanium nitride.

An enhanced reflection film including a high refractive material may be formed on a surface of each of the reflective electrodes.

The high refractive material may be silicon nitride or titanium dioxide.

According to another aspect of the invention, there is provided an electronic apparatus including the above-described electro-optical device.

### BRIEF DESCRIPTION OF THE DRAWINGS

The invention will be described with reference to the accompanying drawings, wherein like numbers reference like elements.

FIG. 1A is a plan view of a display device of Embodiment 1, and FIG. 1B is a side cross-sectional view taken along line IB-IB of FIG. 1A.

FIG. 2 is a pixel circuit diagram showing one kind of a pixel circuit.

FIG. 3 is an enlarged plan view of a pixel unit of a display panel.

FIG. 4 is a side cross-sectional view taken along line IV-IV of FIG. 3.

FIG. 5A is an enlarged side cross-sectional view of the vicinity of a reflective electrode of a display device according to Embodiment 2, and FIG. 5B is an enlarged cross-sectional view of the vicinity of a data line.

FIG. 6 is a plan view of a projector as an electronic apparatus.

FIG. 7A is an enlarged plan view of a pixel unit of a display panel of Modified Example 1, and FIG. 7B is an enlarged view of a VIIB portion of FIG. 7A.

FIG. 8 is an enlarged plan view of a pixel unit of a display device of the related art.

### DESCRIPTION OF EXEMPLARY EMBODIMENTS

Hereinafter, the embodiments of the invention will be described with reference to the accompanying drawings. In addition, in each view used for the following description, the scales of each layer or each member are differentiated from each other in order that each layer or each member has a size capable of being identified in the view.

### Embodiment 1

### Outline of Display Device

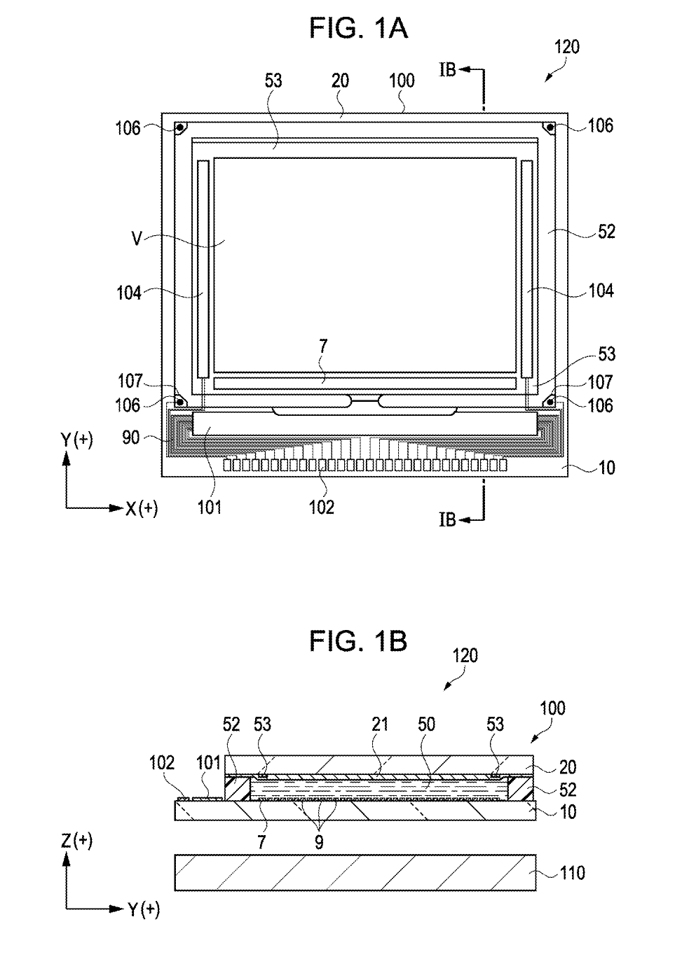

FIG. 1A is a plan view of a display device of Embodiment 1, and FIG. 1B is a side cross-sectional view taken along line IB-IB of FIG. 1A.

First, the overall configuration of the display device 120 as an electro-optical device according to the present embodiment will be described.

The display device 120 is a reflective type liquid crystal display device which reflects light incident from a counter substrate 20 side at a plurality of reflective electrodes 9 arranged on a device substrate 10 side and irradiates light modulated at a liquid crystal layer 50 according to a data signal from the counter substrate 20 side.

As shown in FIG. 1B, the display device 120 includes a display panel 100 in which the liquid crystal layer 50 is interposed between the device substrate 10 and the counter substrate 20 and a light absorber 110 disposed on a rear surface side (device substrate 10 side) of the panel with a interval therebetween.

As a suitable example of the device substrate 10 which is a transparent substrate, a quartz substrate is used. In addition, the substrate is not limited to the quartz substrate and a substrate having transparency in a visible light region may be used.

As a suitable example of the counter substrate 20, alkali-free glass is used. In addition, the substrate is not limited to this configuration, and both the device substrate 10 and the counter substrate 20 may have substrates having transparency in the visible light region.

The liquid crystal layer 50 as an electro-optical layer is enclosed between the device substrate 10 and the counter substrate 20, and the edges of the substrates are adhered by a sealing material 52 including ultraviolet curing resin, thermosetting resin or the like. In the sealing material 52, a gap material (not shown) such as glass fiber or glass beads for maintaining an interval between the device substrate 10 and the counter substrate 20 (a gap between the substrates) is scattered.

As a suitable example of the liquid crystal layer 50, liquid crystal having negative dielectric constant anisotropy, in which one or several types of nematic liquid crystal are mixed, is used. If the liquid crystal is negative liquid crystal in which liquid crystal molecules are vertically aligned when a voltage is not applied and are in a lying state when the voltage is applied, the liquid crystal may include one kind or plural kinds of liquid crystal. The liquid crystal is not limited to the negative liquid crystal and positive liquid crystal may be used. In other words, a mode is not limited to a normally black mode and a normally white mode may be used. In addition, the liquid crystal mode is not limited to a Vertically Aligned (VA) mode, and various operation modes such as a Twisted Nematic (TN) mode or an In-Plane Switching (IPS) mode may be used.

On the counter substrate 20, a frame light shielding film 53 defining parting of a display region V is provided along the inside of a sealing region in which the sealing material 52 is disposed.

One side of the device substrate 10 protrudes from the counter substrate 20, and a data line driving circuit 101 and an external circuit connection terminal 102 are formed in the protruding region (hereinafter, referred to as a “protrusion region”).

A sampling circuit 7 and two scanning line driving circuits 104 are formed outside the display region V and in the inner region of the sealing material 52. In other words, the sampling circuit 7 and the two scanning line driving circuits 104 are disposed to be superimposed on the frame light shielding film 53.

The sampling circuit 7 is provided along the side of the protrusion region side. The two scanning line driving circuits 104 are disposed along two sides adjacent to the sampling circuit 7 with the display region V interposed therebetween. In addition, the two scanning line driving circuits 104 may be formed in the outer region of the sealing material 52.

In addition, in order to electrically connect the two scanning line driving circuits 104 provided at both sides of the display region V, a plurality of wiring lines (not shown) is provided along the remaining one side of the device substrate 10 so as to be covered with the frame light shielding film 53.

In addition, vertical connection portions 106 for performing vertical connection between the device substrate 10 and the counter substrate 20 are disposed on four corners of the outer circumference of the sealing material 52. In the vertical conduction portions 106, for example, an anisotropic conductive material is used, and the wiring lines of the substrates disposed with the anisotropic conductive material interposed therebetween are electrically connected.

On the device substrate 10, routed wiring lines 90 for electrically connecting the external circuit connection terminal 102, the data line driving circuit 101, the scanning line driving circuits 104, the vertical connection portions 106, and the like are formed.

In the horizontally long rectangular display region V of FIG. 1A, a plurality of pixels forming an image is formed in a matrix.

In the views including FIG. 1, a horizontal direction of the horizontally long rectangular display region V is defined as an X axis direction and a vertical direction crossing the above direction is defined as a Y axis direction. A thickness direction of the display device 120 is a Z axis direction. A Z axis (+) direction from the device substrate 10 to the counter substrate 20 is an upper layer (an upper side) and the opposite direction thereof, that is, the Z axis (−) direction is a lower layer (a lower side).

On the device substrate 10 of FIG. 1B, the pixels have a lamination structure in which the reflective electrodes 9 arranged in a matrix are formed as an uppermost layer, and pixel switching Thin Film Transistors (TFT), scanning lines, data lines, an interlayer insulating film, and the like are laminated.

On the reflective electrodes 9, an alignment film is formed so as to cover the reflective electrodes. On a lower surface of the counter substrate 20, a counter electrode 21 including a transparent conductive material such as Indium Tin Oxide (ITO) is formed substantially on the entire surface (common) so as to face the plurality of reflective electrodes 9. An alignment film is also formed on the counter electrode 21.

The liquid crystal layer 50 is in a predetermined alignment state between a pair of alignment films. Although not shown, on the device substrate 10, in addition to the data line driving circuit 101 and the scanning line driving circuits 104, an inspection circuit for detecting the quality, defect and the like of the liquid crystal device during manufacturing or before shipment, an inspection pattern and the like may be further formed.

Although, in FIG. 1B, a light absorber 110 is independently shown under the display panel 100 in a state of being separated from the panel, the invention is not limited to this configuration and an interval, that is, an air layer may be formed between the display panel 100 and the light absorber 110. For example, the display panel 100 and the light absorber 110 may be integrally formed in a state of being separated from each other by a support frame (not shown) including frame-shaped resin.

The light absorber 110 is a sheet member, the plane size of which is substantially identical to the size of the display panel 100, and, as a suitable example thereof, a black aluminum plate subjected to alumite treatment is used. In addition, the invention is not limited to this material and a material having excellent visible light absorption property and high thermal conductivity may be used. For example, a glass substrate subjected to black coating with high light absorption property may be used.

In addition, in the plane size of the light absorber, the size equal to or greater than that of the display region V is preferable, and a net-like (lattice-like) configuration for covering a portion overlapping a space between neighboring reflective electrodes 9 may be used.

### Pixel Circuit

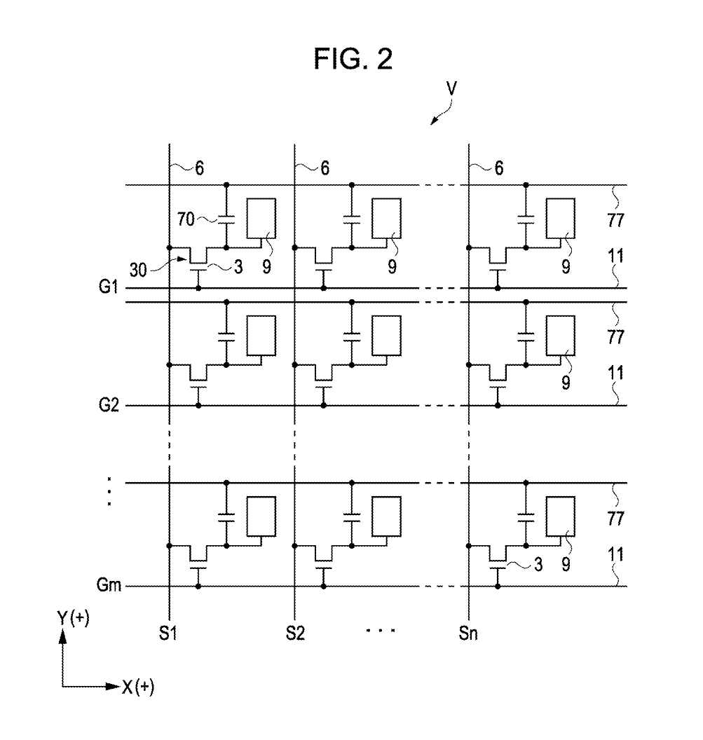

FIG. 2 is a pixel circuit diagram showing one kind of a pixel circuit of the present embodiment.

Next, the pixel circuit of the display panel 100 will be described.

As shown in FIG. 2, in the display region V of the display panel 100, a plurality of scanning lines 11 extend along the X axis direction. A plurality of data lines 6 extend along the Y axis direction so as to cross the plurality of scanning lines 11.

In addition, a plurality of capacitive lines 77 is disposed along the extension direction (X axis direction) of the plurality of scanning lines 11. Alternatively, the capacitive lines 77 may be disposed along the extension direction (Y axis direction) of the data lines 6.

A plurality of pixels forming the display region V are formed at intersections in which the scanning lines 11 and the data lines 6 cross each other.

Each pixel includes a transistor 30 and a storage capacitor 70 in addition to the above-described reflective electrode 9. As a suitable example of the transistor 30, a field effect N-type transistor is used.

In each transistor 30, a gate terminal is connected to a corresponding scanning line 11, a source terminal is connected to a corresponding data line 6, and a drain terminal is connected to the reflective electrode 9 and one end of the storage capacitor 70. The other end of the storage capacitor 70 is connected to a corresponding capacitive line 77.

The transistors 30 write the data signals S1, S2, . . . , and Sn of the data lines 6 to the reflective electrodes 9 corresponding thereto at timings selected by the scanning signals G1, G2, . . . , and Gm supplied to the scanning lines 11. That is, the pixels are line-sequentially selected according to the timings of the scanning signals G1, G2, . . . , and Gm supplied from the scanning line driving circuits 104 to the scanning lines 11. The data signals S1, S2, . . . , and Sn are supplied from the data line driving circuit 101 and the sampling circuit 7 to the data lines 6 in synchronization with the selection of the pixels by the scanning signals. In detail, the sampling circuit 7 simultaneously samples six phase-expanded image signals according to the timings of the sampling signals supplied from the data line driving circuit 101 to six consecutive data lines and supplies the sampled image signals to the data lines. Although the phase-expanded driving of six phases is described as a suitable example, the invention is not limited thereto and a driving method capable of displaying an image at a predetermined frame rate without a sense of discomfort is possible.

In this way, the data signals S1, S2, . . . , and Sn having a predetermined level, which are written to the liquid crystal layer 50 through the reflective electrodes 9, are held for a predetermined period between the counter electrode formed on the counter substrate 20 and the reflective electrodes.

In order to hold the potentials of the written data signals, the storage capacitors 70 are electrically formed in parallel to the liquid crystal capacitor formed between the reflective electrodes 9 and the counter electrode 21. The other ends of the storage capacitors 70 are connected to the capacitive lines 77 set to a predetermined potential.

The counter electrode 21 (FIG. 1B) of the counter substrate 20 is connected to a counter electrode generation circuit (not shown) such that a counter voltage, the polarity of which is periodically reversed, is supplied so as to perform reversal driving. As the reversal driving, line reversal driving, frame reversal driving, dot reversal driving or the like may be used.

### Detailed Configuration of Display Panel

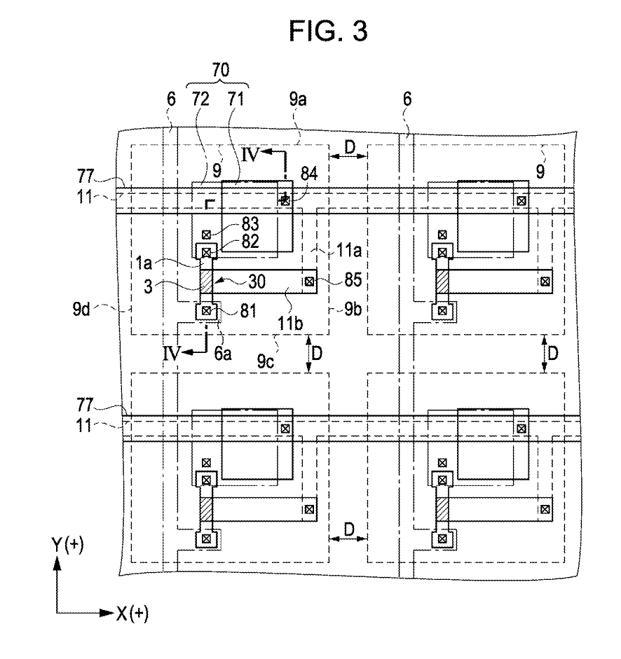

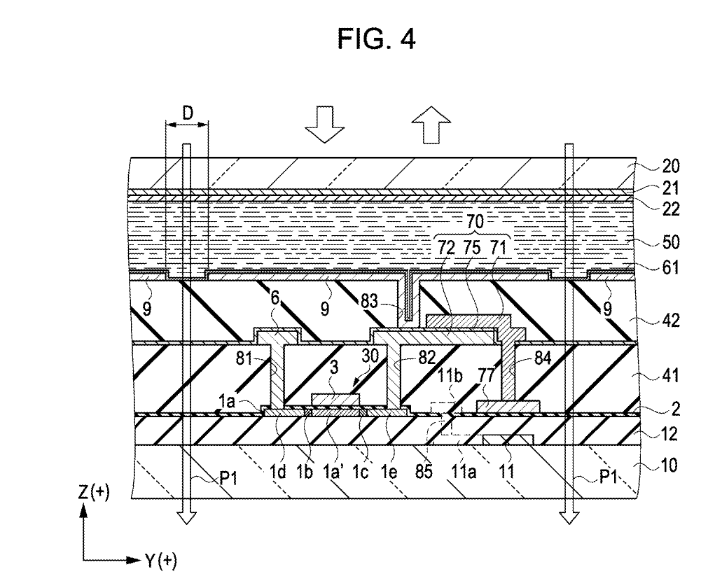

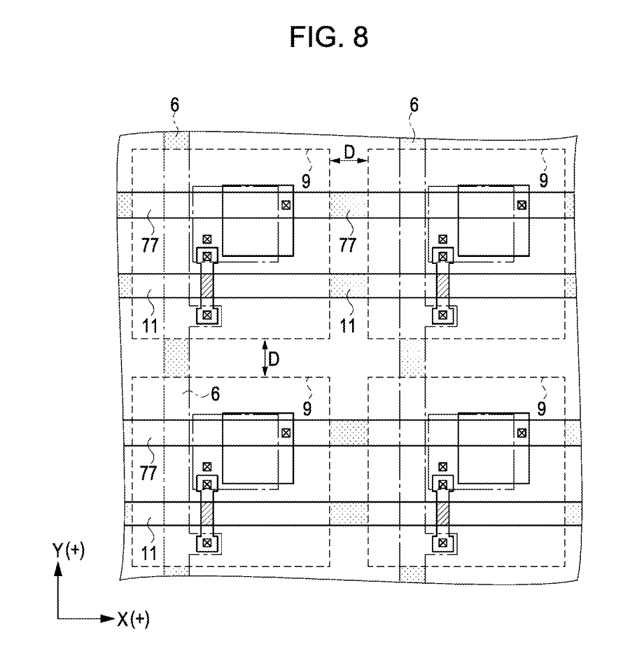

FIG. 3 is an enlarged plan view of a pixel unit of a display panel, which corresponds to FIG. 8. FIG. 4 is a side cross-sectional view taken along line IV-IV of FIG. 3.

Now, the configuration of the display panel 100 will be described in detail.

FIG. 3 is a perspective plan view of enlarging the vicinities of any four pixels in the display region V. The reflective electrode 9 of each pixel is formed at the intersection in which the scanning line 11 and the data line 6 cross. In detail, the reflective electrode 9 having substantially a square shape is formed so as to cover the intersection corresponding thereto. In addition, the capacitive lines 77 extend in the X axis direction, similar to the scanning lines 11.

The capacitive lines 77 denoted by a solid line and the scanning lines 11 denoted by a dotted line are formed so as to overlap. In detail, the scanning lines 11 are formed on the lower layers of the capacitive lines 77 and only the capacitive lines 77 are observed in plan view. In other words, only the capacitive lines 77 are exposed on the display region V side.

This is the most characteristic feature of the present embodiment and, in particular, only the capacitive lines 77 are exposed between the reflective electrodes along the Y axis direction.

Since FIG. 3 is a perspective plan view, the reflective electrodes 9 are denoted by a dotted line. In the cross-sectional view, as shown in FIG. 4, the reflective electrodes 9 are located on an uppermost layer (fourth layer) of the lamination structure formed on the device substrate 10.

The transistors 30 or the storage capacitors 70 configuring the pixels are formed on the lower layer of the reflective electrodes 9. In other words, the transistors 30 or the storage capacitors 70 are covered with the reflective electrodes 9.

In the case of facing to FIG. 3, when the sides of one reflective electrode 9 are an upper side 9a, a right side 9b, a lower side 9c, and a left side 9d, the scanning line 11 (capacitive line 77) is disposed along the upper side 9a in the vicinity thereof. In addition, the data line 6 is disposed along the left side 9d in the vicinity thereof.

The storage capacitor 70 has substantially a horizontally long rectangular shape, partially overlaps the scanning line 11, and is disposed on the right side (X axis (+) side) of the data line 6. In other words, the storage capacitor is disposed so as to be slightly biased to the upper side (Y axis (+) side) of the center of the reflective electrode 9.

The transistor 30 is disposed on the right side of the data line 6 and is disposed between the distal end of a branched wiring line 6a branched from the data line 6 to the X axis (+) side and the storage capacitor 70. In other words, the transistor is disposed on the left lower side from the center of the reflective electrode 9.

Hereinafter, the configuration for realizing this configuration will be described in detail.

As shown in FIG. 4, the lamination structure is a four-layer structure including a first layer including the scanning lines 11, a second layer including the transistors 30 or the capacitive lines 77, a third layer including the storage capacitors 70 and a fourth layer including the reflective electrodes 9 on the device substrate 10.

The following wiring lines, circuit elements, insulating films and the like may be formed by a deposition method, a sputtering method, a Chemical Vapor Deposition (CVD) method, a photolithographic method, an etching method alone, or a combination thereof.

First, the first layer includes the scanning lines 11, an underlying insulating film 12, and the like.

The scanning lines 11 are electrical wiring lines formed on the device substrate 10 and include aluminum or an alloy (aluminum alloy) mainly containing aluminum as a suitable example. The invention is not limited to this configuration and electrical wiring lines securing desired conductivity may be used.

For example, wiring lines having a two-layer structure in which aluminum and titanium nitride are sequentially laminated may be used. Since titanium nitride functions as a light shielding film, it is possible to suppress reflection even when the scanning lines 11 protrude from the capacitive lines 77 in plan view.

The underlying insulating film 12 including a transparent inorganic film such as a silicon oxide film or a silicon nitride is formed on the device substrate 10 and the scanning lines 11, as a suitable example. In the underlying insulating film 12, contact holes 85 for connecting the scanning lines 11 and the gate electrodes 3 of the transistors 30 are formed.

As shown in FIG. 3, in plan view, in a region with which the reflective electrodes 9 overlap, branched wiring lines 11a branched in the Y axis direction from the scanning lines 11 extending in the X axis direction are formed, and the contact holes 85 are formed in the distal ends of the branched wiring lines. By the contact holes 85, branched wiring lines 11b extending from the gate electrodes 3 of the upper layer are electrically connected to the branched wiring lines 11a.

Description returns to FIG. 4.

The second layer includes the capacitive lines 77, the transistors 30, an interlayer insulating film 41, and the like. On the underlying insulating film 12, as a suitable example, a semiconductor layer 1a including a high-temperature polysilicon film is formed. In addition, on the underlying insulating film 12 and the semiconductor layer 1a, a gate insulating film 2 including an inorganic insulating material such as a silicon oxide film is formed.

On the gate insulating film 2, the gate electrodes 3 including the polysilicon film and the capacitive lines 77 are formed. The invention is not limited to this material, and, in addition to the conductive polysilicon film, high-melting-point metal such as titanium (Ti), Chrome (Cr), tungsten (W), tantalum (Ta) or molybdenum (Mo), metal silicide polysilicide, an alloy thereof or such a laminate thereof may be used.

Through the lamination structure from the semiconductor layer 1a to the gate electrodes 3, the transistors 30 are formed. As a suitable example of the transistors 30, a Lightly Doped Drain (LDD) structure is employed.

In detail, each transistor 30 includes the gate electrode 3, a channel region 1a′ of the semiconductor layer 1a in which a channel is formed by an electric field from the gate electrode 3, and a low-concentration source region 1b, a low-concentration drain region 1c, a high-concentration source region 1d and a high-concentration drain region 1e of the semiconductor layer 1a. In addition, the invention is not limited to this configuration, a configuration using low-temperature polysilicon or amorphous silicon as the semiconductor layer 1a may be used.

In addition, although the transistors 30 of the present embodiment are of a top gate type, bottom gate type transistors may be used.

In addition, an interlayer insulating film 41 including a silicon oxide film, a silicon nitride film or the like is formed so as to cover the gate insulating film 2, the gate electrodes 3 and the capacitive lines 77. The invention is not limited to this material, and silicate glass such as non silicate glass (NSG), phosphorous silicate glass (PSG), boron silicate glass (BSG), boron phosphorous silicate glass (BPSG) may be used. In the interlayer insulating film 41, contact holes 81, 82 and 84 are formed.

The contact holes 81 electrically connect the high-concentration source regions 1d (source electrodes) of the transistors 30 and the data lines 6 of the third layer.

The contact holes 82 electrically connect the high-concentration drain region 1e (drain electrodes) of the transistors 30 and the lower electrodes 72 of the storage capacitors 70 of the third layer.

The contact holes 84 electrically connect the capacitive lines 77 and the upper electrodes 71 of the storage capacitors 70 of the third layer.

As shown in FIG. 3, in plan view, the semiconductor layer 1a is formed on the X axis (+) side along the data lines 6, and the hatched gate electrode 3 is formed on substantially the central portion of the longitudinal direction thereof. In addition, the contact hole 81 and the contact hole 82 are formed in both ends of the longitudinal direction.

The branched wiring line lib extends from the gate electrode 3 formed on the channel region along the X axis (+) direction and the contact hole 85 is formed in the distal end thereof.

In addition, the contact hole 81 is formed in the distal end of the branched wiring line 6a of the data line 6.

The contact hole 82 is formed in the corner of the lower electrode 72 of the storage capacitor 70.

Description returns to FIG. 4.

The third layer includes the data lines 6, the storage capacitors 70, the interlayer insulating film 42, and the like.

The data lines 6 are electrical wiring lines formed on the interlayer insulating film 41 and include aluminum or aluminum alloy as a suitable example. The invention is not limited to this configuration and electrical wiring lines securing the desired conductivity may be used. For example, similar to the scanning lines 11, a lamination configuration including a plurality of layers may be used.

Each storage capacitor 70 includes the lower electrode 72, a dielectric film 75, an upper electrode 71, and the like. In other words, the dielectric film 75 is interposed between the lower electrode 72 and the upper electrode 71.

The lower electrode 72 is formed on the same layer as the data lines 6, that is, includes a metal layer such as aluminum, as a suitable example. The lower electrode 72 is electrically connected to the drain electrode le of the transistor 30 through the contact hole 82 formed in the interlayer insulating film 41.

In addition, the lower electrode 72 is electrically connected to the reflective electrode 9 through the contact hole 83 formed in the interlayer insulating film 42. That is, the reflective electrode 9 and the drain electrode le of the transistor 30 are connected through the lower electrode 72.

The dielectric film 75 is formed so as to cover the interlayer insulating film 41, the data line 6 and the lower electrode 72 and includes a silicon nitride film with a high dielectric constant as a suitable example. The invention is not limited to this material, and a film including hafnium oxide (HfO₂), alumina (Al₂O₃), tantalum oxide (Ta₂O₅) or a laminate thereof may be used.

The upper electrode 71 includes aluminum or aluminum alloy as a suitable example. The invention is not limited to this material and may include, for example, conductive polysilicon. The upper electrode 71 is electrically connected to the capacitive line 77 through the contact hole 84 penetrated through the dielectric film 75 and the interlayer insulating film 41.

The interlayer insulating film 42 is formed so as to cover the dielectric film 75 and the upper electrode 71. In addition, the interlayer insulating film 42 includes the same material as the interlayer insulating film 41.

As shown in FIG. 3, in plan view, the lower electrode 72 and the upper electrode 71 each having substantially a horizontally long rectangular shape are disposed in substantially an overlapping state.

The contact hole 83 is formed on substantially the center of the reflective electrode 9, and, in detail, is disposed between the data line 6 and the upper electrode 71.

Description returns to FIG. 4.

The fourth layer includes the reflective electrodes 9, an alignment film 61 and the like.

The reflective electrodes 9 include aluminum or aluminum alloy with excellent reflectivity as a suitable example. The invention is not limited to this material and a material securing desired conductivity and having excellent reflectivity may be used. Alternatively, a reflection film having reflectivity may be formed on the pixel electrode.

The alignment film 61 is formed so as to cover the interlayer insulating film 42 and the reflective electrodes 9 and is subjected to a predetermined alignment process such as a rubbing process.

On the interlayer insulating film 42 and the reflective electrodes 9, the alignment film 61 may be formed after a planarization layer such as a silicon oxide film or a silicon nitride film is formed.

As shown in FIG. 3, in plan view, the plurality of reflective electrodes 9 is disposed so as to be separated at the interval D in order to prevent a short circuit between neighboring reflective electrodes 9. In other words, the interval D is provided in a lattice shape so as to partition the plurality of reflective electrodes 9.

Up to now, the lamination structure of the device substrate 10 side was described in detail.

Description returns to FIG. 4.

On the counter substrate 20, the counter electrode 21 and an alignment film 22 are sequentially laminated. The counter electrode 21 includes an ITO film as a suitable example. The alignment film 22 is identical to the alignment film 61.

### Examples of Dimensions in a Suitable Example

Now, using FIG. 3, examples of the plane dimension in the case where the lamination structure of the display panel 100 is configured as the above-described suitable example will be described. The examples of the dimensions were obtained by the trial production evaluation by inventors.

First, the dimension of the reflective electrode 9 was a square of “8.0 μm×8.0 μm”. The interval D between the reflective electrodes 9 was 0.5 μm in the X axis direction and the Y axis direction.

That is, the reflective electrode 9 of 8.0 μm was formed at vertical and horizontal pitches of 8.5 μm in a matrix.

In addition, the width of the scanning line 11 was 1.25 μm and the width of the capacitive line 77 was 2.25 μm. Accordingly, the ratio of the width of the capacitive line 77 occupying the length of the right side 9b of the reflective electrode 9 was “2.25/8.0”. The same is true in the left side 9d of the reflective electrode 9.

In addition, the width of the data line 6 was 1.25 μm. Accordingly, the ratio of the width of the data line 6 occupying the length of the upper side 9a of the reflective electrode 9 was “1.25/8.0”. The same is true in the lower side 9c of the reflective electrode 9.

The width of the capacitive line 77 is wider than that of the scanning line 11 or the data line 6 by a difference in a wiring line material. In detail, since the conductivity of the polysilicon film of the capacitive line 77 is lower than that of the aluminum used in the scanning line 11 or the data line 6, it is necessary to increase the width in order to secure the necessary conductivity as the electrical wiring line. To this end, the width of the branched wiring line 11a of the scanning line was 1.25 μm, but the width of the branched wiring line 11b was 2.25 μm.

Although the configuration in which the scanning lines 11 are covered (hidden) with the capacitive lines 77, that is, the configuration in which only the capacitive lines 77 are exposed from the interval D, is described, the invention is not limited thereto and, in the interval D, the configuration in which the scanning lines 11 and the capacitive lines 77 partially overlap each other may be used. For example, in the interval D, in plan view, the scanning lines 11 may protrude from the capacitive lines 77. Even in this configuration, if the capacitive lines 77 and the scanning lines 11 partially overlap, it is possible to reduce the wiring line portion exposed from the interval D corresponding to the overlapping portion.

In addition, the invention is not limited to the configuration in which the capacitive lines 77 are located on the upper layer of the scanning lines 11 and, if both lines partially overlap, the scanning lines 11 may be located on the higher layer of the capacitive lines 77. Even in this configuration, it is possible to reduce the wiring line portion exposed from the interval D corresponding to the overlapping portion of both lines.

Although the case where the extension direction of the capacitive lines 77 is identical to the extension direction of the scanning lines 11 is described, the invention is not limited to this configuration, and the extension direction of the capacitive lines 77 may be identical to the extension direction of the data lines 6.

In detail, in the interval D, the configuration in which the data lines 6 and the capacitive lines 77 partially overlap may be used. It is possible to reduce the wiring line portion exposed from the interval D corresponding to the overlapping portion. In addition, in the lamination structure, the hierarchical relationship between both lines is as described above. In this case, after the circuit wiring line of FIG. 2 is preserved, it is necessary to set the extension direction of the capacitive lines 77 to the wiring line along the data lines 6 and the lamination structure.

That is, in the interval D, if the configuration in which the scanning lines 11 and the capacitive lines 77 partially overlap or the data lines 6 and the capacitive lines 77 partially overlap is used, the lamination structure and the wiring line shape for realizing the configuration may be arbitrarily set.

As described above, according to the display device 120 of the present embodiment, the following effect can be obtained.

According to the display device 120, in the interval D, since the capacitive lines 77 and the scanning lines 11 are configured so as to overlap, it is possible to set the ratio occupied by the wiring line between the reflective electrodes 9 to be less than that of the display device of the related art corresponding to the overlapping portion of the two wiring lines. In detail, the wiring lines exposed to the interval D in the X axis direction may be set to only the capacitive lines 77.

Accordingly, since the quantity of light reflected from the wiring lines is reduced in the interval D, it is possible to increase display contrast compared with the display device of the related art and to obtain desired display contrast.

Accordingly, it is possible to provide the display device 120 with sufficient contrast.

By forming the capacitive lines 77 having a width greater than that of the scanning lines 11 on the upper layer of the scanning lines 11, it is possible to efficiently cover the scanning lines 11. In other words, by setting the hierarchical relationship between the wiring lines according to the characteristics of the wiring line material, it is possible to reduce the wiring line amount (area) occupied in the interval D. In detail, since the capacitive lines 77 are the same layer as the gate electrodes 3 and are formed by the same process, the capacitive lines may include a polysilicon film with conductivity lower than that of aluminum used in the scanning lines 11 or the data lines 6.

Accordingly, in order to secure necessary conductivity as the electrical wiring lines, the capacitive lines have the width greater than that of the scanning lines 11, but, using this characteristic, the capacitive lines are formed on the upper layer of the scanning lines 11 so as to efficiently cover and hide the scanning lines 11. Thus, it is possible to prevent the scanning lines 11 from be exposed to the interval D.

Accordingly, it is possible to obtain sufficient display contrast.

In addition, the device substrate 10 includes a transparent substrate and the circuit elements are disposed on the lower layer of the reflective electrodes 9 so as to cover the circuit elements such as the transistors 30 with the reflective electrodes 9. A light absorber 110 is disposed on a rear surface side of the device substrate 10.

According to this configuration, since light incident to the interval D transmits the transparent device substrate 10 so as to be absorbed into the light absorber 110, it is possible to suppress generation of stray light and to prevent malfunction of the circuit elements.

Accordingly, it is possible to provide the display device 120 capable of obtaining a stable image.

The light absorber 110 is disposed at the lower side (rear surface) of the display panel 100 in a state of being separated from the panel. That is, an interval (air layer) is interposed between the display panel 100 and the light absorber 110.

Accordingly, even when the light absorber 110 is heated by the light transmitting the interval D, it is possible to prevent the heat of the light absorber 110 from being directly transferred to the display panel 100. That is, by the configuration in which the display panel 100 and the light absorber 110 are substantially thermally independent of each other, it is possible to reduce heat generation of the display panel, compared with the display device of the related art, in which the light absorber and the display panel are adhered.

Accordingly, it is possible to provide the display device 120 which suppresses deterioration due to overheating. In other words, it is possible to provide the display device 120 with excellent reliability.

### Embodiment 2

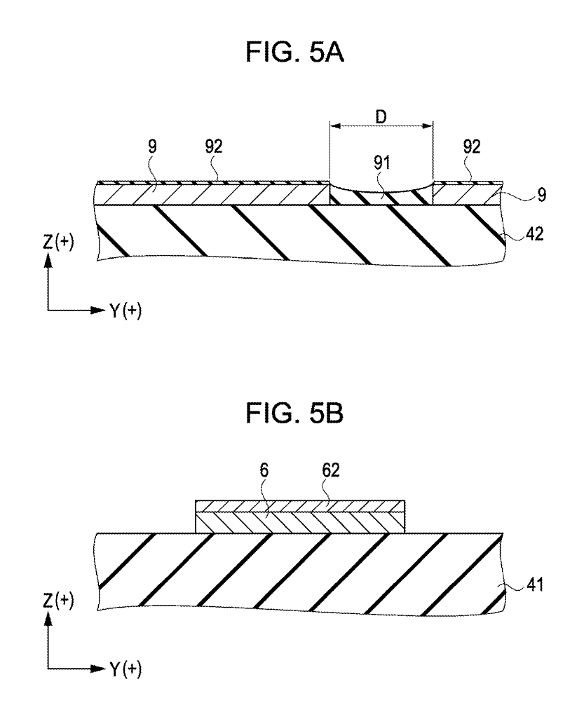

FIG. 5A is an enlarged side cross-sectional view of the vicinity of a reflective electrode of a display device according to Embodiment 2, and FIG. 5B is an enlarged cross-sectional view of the vicinity of a data line, both of which correspond to FIG. 4.

Hereinafter, the display device according to Embodiment 2 of the invention will be described. The same components as Embodiment 1 are denoted by the same reference numerals and the description thereof will be omitted.

First, the basic configuration of the display device according to the present embodiment is substantially identical to the configuration of the display device 120 of Embodiment 1. In the present embodiment, the configuration of the wiring lines exposed to the interval D and the configuration of the reflective electrode are different from Embodiment 1. The other portions are equal to the description of Embodiment 1.

FIG. 5A is an enlarged view of the vicinity of the reflective electrode 9 of a fourth layer of FIG. 4, which shows the peripheral configuration of two neighboring reflective electrodes and the interval D between the electrodes. In the display device of the present embodiment, an enhanced reflection film 92 is formed on a surface of the reflective electrode 9.

In addition, FIG. 5B is an enlarged view of the vicinity of the data line of the third layer of FIG. 4, which shows the configuration of the data line 6. In the display device of the present embodiment, an anti-reflection film 62 is formed on a surface of the data line 6.

The display device of the present embodiment is characterized in that the enhanced reflection film 92 is formed on the surface of the reflective electrode 9 and the anti-reflection film is provided on the surface of the wiring line exposed to the interval D. The other configuration is identical to the configuration of the display device 120 of Embodiment 1.

On the interlayer insulating film 42 of FIG. 5A, in the interval D, an insulating layer 91 including a silicon oxide film is formed.

In addition, the enhanced reflection film 92 of the surface of the reflective electrode 9 includes a silicon nitride (SiN) film. In addition, the invention is not limited to this material and a material which is transparent in the visible light region and has a high refractive index, for example, titanium dioxide (TiO₂) may be used.

As such a forming method, after the reflective electrode 9 is formed, a silicon oxide film is deposited on the interlayer insulating film 42 and the reflective electrode 9 by a CVD method. Subsequently, the silicon oxide film is dry etched (etched-back) so as to expose a surface of the reflective electrode 9. At this time, since the silicon oxide film of the interval D is slightly over-etched, a concave shape is drawn in FIG. 5A.

Then, the enhanced reflection film 92 is formed on the exposed surface of the reflective electrode 9 using a CVD method and a photolithographic method.

In FIG. 5B, the data line 6 is the wiring line including aluminum alloy and the anti-reflection film 62 laminated thereon includes a titanium nitride (TiN) film. In addition, although the anti-reflection film 62 is preferably formed on the entire surface of the data line 6, it may be selectively formed only on the wiring line portion exposed from the interval D.

As such a forming method, a vacuum deposition method, a sputtering method, a photolithographic method, or the like may be used. In detail, after the data line 6 is formed, the titanium nitride film is selectively formed on the data line 6.

Although the case where the anti-reflection film 62 is formed on the surface of the data line 6 is described, similarly, the anti-reflection film is formed on the surface of the capacitive line 77 exposed from the interval D. In detail, the anti-reflection film including the titanium nitride film is formed on the capacitive line 77 of FIG. 4 using a vacuum deposition method, a sputtering method, a photolithographic method, or the like.

As described above, although two configurations, that is, the configuration in which the enhanced reflection film 92 is formed on the surface of the reflective electrode 9 and the configuration in which the anti-reflection film is provided on the surface of the wiring line exposed to the interval D, are preferably included, only one configuration may be used. Even when any one configuration is used, it is possible to increase contrast.

As described above, according to the display device of the present embodiment, in addition to the effects of Embodiment 1, the following effects can be obtained.

According to the display device of Embodiment 2, the enhanced reflection film 92 is formed on the surface of each reflective electrode 9 and the anti-reflection film is formed on the surface of the data line 6 and the surface of the capacitive line 77 exposed in the interval D.

Accordingly, since the reflectivity of the display light by each reflective electrode 9 is increased so as to improve the luminance of the display light and the quantity of light reflected from the wiring line of the interval D is reduced, display contrast is increased. Therefore, it is possible to provide a display device capable of obtaining sufficient contrast.

### Electronic Apparatus

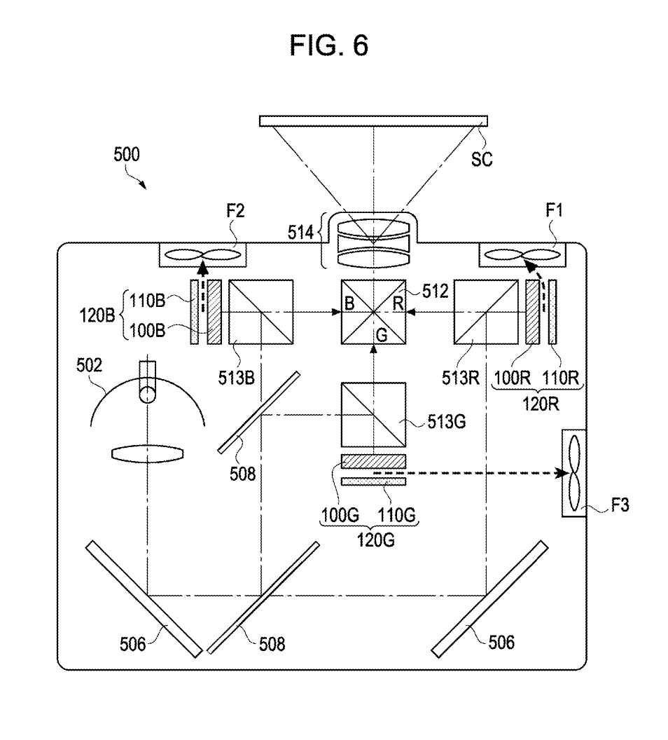

FIG. 6 is a plan view illustrating the configuration of a projector as a three-plate electronic apparatus using the above-described display device as a light valve.

Next, an example of the electronic apparatus using the display device according to the above-described embodiments will be described.

A projector 500 is a three-plate liquid crystal projector using three light valves, that is, light valves 120R, 120G and 120B for respective colors RGB.

The above-described display devices are used in the light valves 120R, 120G and 120B, and the light valves are driven by image signals corresponding to respective colors R, G and B supplied from an external high-level device (not shown).

In the projector 500, if projection light is emitted from a lamp unit 502 for emitting substantially white light, such as a metal halide lamp, substantially white light is separated into three primary colors of RGB by an optical action of two mirrors 506 and two dichroic mirrors 508.

Then, the separated color light beams of RGB enter polarized beam splitter (PBS) 513R, 513G and 513B corresponding thereto so as to be guided to the light valves 120R, 120G and 120B. At this time, in order to prevent light loss of each optical path, a lens may be appropriately provided partway on each optical path.

The color modulated light beams reflected from the light valves 120R, 120G and 120B and modulated according to image signals enter the dichroic prism 512 from three directions. In addition, in the dichroic prism 512, the R light beam and the B light beam are refracted by 90 degrees by the optical action of the dichroic film therein and the G light beam goes straight.

The light showing a color image synthesized in the dichroic prism 512 is enlarged and projected by a lens unit 514 such that a full-color image is displayed on a screen Sc.

According to the projector 500 using the display device of the above embodiments as the light valve, it is possible to mirror a projection image with sufficient contrast.

Since the color light beams of RGB enter the light valves 120R, 120G and 120B by the optical action of the two mirrors 506 and the two dichroic mirrors 508, it is not necessary to provide color filters.

Since the projection images of the light valves 120R and 120B are projected after being reflected from the dichroic prism 512, but the projection image of the light valve 120G is projected without change, the images formed by the light valves 120R and 120B and the image formed by the light valve 120G are set to become a horizontal inversion relationship.

The display panel 100 and the light absorber 110 of each of the light valves 120R, 120G and 120B are disposed at an interval by a support frame in a solid-state projector. Ventilation fans F1, F2 and F3 are respectively provided in the light valves 120R, 120G and 120B.

For example, in the light valve 120R, the ventilation fan F1 for externally ventilating air in the solid-state projector including air of an interval region between the display panel 100R and the light absorber 110R is provided. Thus, it is possible to efficiently cool the display panel 100R and the light absorber 110R.

Similarly, the ventilation fan F3 is provided in the light valve 120G and the ventilation fan F2 is provided in the light valve 120B. In addition, the number of ventilation fans is not limited to three and the number of ventilation fans may be one if air (hot air) of each interval portion may be ventilated.

By this configuration, it is possible to prevent the display panel 100 from being directly heated by the heat of the light absorber 110 and to prevent the display panel from being indirectly heated through air of the interval portion.

Accordingly, it is possible to provide the projector 500 capable of suppressing deterioration due to overheating. In other words, it is possible to provide the projector 500 with excellent reliability.

In addition to the electronic apparatus described in FIG. 6, there are a rear projection type television, a direct-view monitor of, for example, a cellular phone, a personal computer or a monitor of a video camera, a car navigation system, a pager, an electronic organizer, an electronic calculator, a word processor, a workstation, a videophone, a POS terminal, a digital still camera, a touch-panel-equipped device, and the like. The display devices according to the above embodiments are applicable to such electronic apparatus.

The invention is not limited to the above-described embodiments and various modifications or changes of the above-described embodiments may be made. Modified examples will now be described.

### Modified Example 1

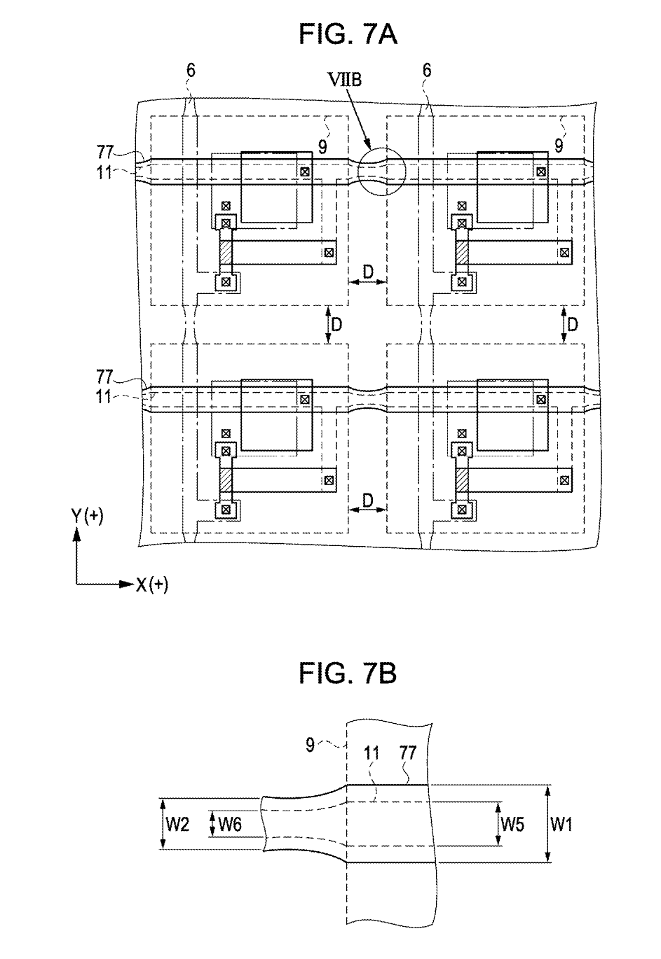

FIG. 7A is an enlarged plan view of a pixel unit of a display panel of Modified Example 1, which corresponds to FIG. 3, and FIG. 7B is an enlarged view of a VIIB portion of FIG. 7A.

Hereinafter, the display device of Modified Example 1 will be described. The same components as Embodiment 1 are denoted by the same reference numerals and the description thereof will be omitted.

Although, in the above embodiment, the widths of the wiring lines are substantially identical in the same layer of the lamination structure, the invention is not limited to this configuration, and the wiring line width may be changed in the portion covered with the reflective electrode 9 and the portion exposed to the interval D.

In the display panel according to Modified Example 1, the wiring line width of the portion exposed to the interval D is narrower than that of the portion covered with the reflective electrode 9.

In detail, as shown in FIG. 7, the thicknesses of the capacitive line 77, the scanning line 11 and the data line 6 of the interval D are narrower than that of the lower layer portion of the reflective electrode 9.

For example, in the case of the capacitive line 77, as shown in FIG. 7B, the width thereof is gradually decreased from the wiring line width W1 of the portion overlapping the reflective electrode 9 to the wiring line width W2 of the interval D. As a suitable example, the ratio of the wiring line width is set in a range of “W2/W1=0.6 to 0.8”.

Similarly, with respect to the scanning line 11, the ratio of the wiring line width is set in a range of “W6/W5=0.6 to 0.8”, but is set such that the wiring line width W6 of the interval D is equal to or less than the wiring line width W2 of the narrowest portion of the capacitive line 77.

The data line 6 is set similar to the case of the capacitive line 77. The other configuration is identical to the configuration of each of the above-described display devices.

According to the display device of Modified Example 1, since the wiring line width of the portion exposed from the interval D narrows, it is possible to reduce the ratio (area) of the wiring line portion occupying the interval D.

Accordingly, since the quantity of light reflected from the wiring line in the interval D is reduced, it is possible to further increase display contrast.

Accordingly, it is possible to provide a display device capable of obtaining sufficient contrast.

In addition, even when the wiring line width of the interval D narrows, as described above, since the length (width) of the interval D is as short as about 0.5 μm, a problem does not occur in practice in the ratio of the range of the suitable example. However, in order to align wiring line resistance with the large width portion, the thickness of the wiring line of the interval D may be increased so as to make the wiring line resistance uniform.

### Modified Example 2

Description will be given using FIG. 4.

Hereinafter, a display device of Modified Example 2 will be described. The same components as Embodiment 1 are denoted by the same reference numerals and the description thereof will be omitted.

Although, in the above embodiments, the device substrate 10 is described as a quartz substrate, the invention is not limited to this configuration and a sapphire substrate having transparency in the visible light region may be used.

If the sapphire substrate is used as the device substrate 10, similar to the quartz substrate, it is possible to transmit the light incident from the interval D and to improve performance including an operation speed of the transistor 30. In detail, if the sapphire substrate is used, it is possible to form the semiconductor layer 1a including a single crystal silicon film on the device substrate 10.

Accordingly, it is possible to improve the performance of the transistor 30, compared with the case where the semiconductor layer 1a includes a polysilicon film. Therefore, it is possible to provide a display device with excellent display response.

What is claimed is:

1. An electro-optical device comprising:
a transparent substrate;
a plurality of scanning lines formed over the transparent substrate;
a plurality of data lines crossing the plurality of scanning lines;
a plurality of capacitive lines formed along an extension direction of the plurality of scanning lines or the plurality of data lines; and
reflective electrodes disposed at intersections, in which the plurality of scanning lines and the plurality of data lines cross, over the plurality of scanning lines, the plurality of data lines and the plurality of capacitive lines,
the plurality of scanning lines and the plurality of capacitive lines or the plurality of data lines and the plurality of capacitive lines being partially overlapped between the reflective electrodes.

2. The electro-optical device according to claim 1, wherein one wiring lines of the plurality of scanning lines and the plurality of capacitive lines or the plurality of data lines and the plurality of capacitive lines is disposed between other wiring lines and the reflective electrodes, each of the other wiring lines is covered with one of the one wiring lines.

3. The electro-optical device according to claim 1, wherein the wiring line is formed such that the wiring line width between the reflective electrodes is narrower than the wiring line width of a region overlapping the reflective electrodes.

4. The electro-optical device according to claim 1, wherein the transparent substrate is a quartz substrate or a sapphire substrate.

5. The electro-optical device according to claim 1, further comprising a light absorber configured to absorb light transmitting between the reflective electrodes at a side opposed to the reflective electrodes of the transparent substrate, wherein the light absorber is disposed so as to be separated from the transparent substrate.

6. The electro-optical device according to claim 1, wherein an anti-reflection film is formed on a surface of the wiring line exposed between the reflective electrodes.

7. The electro-optical device according to claim 6, wherein the anti-reflection film includes titanium nitride.

8. The electro-optical device according to claim 1, wherein an enhanced reflection film including a high refractive material is formed on a surface of each of the reflective electrodes.

9. The electro-optical device according to claim 8, wherein the high refractive material is silicon nitride or titanium dioxide.

10. An electro-optical apparatus comprising the electro-optical device according to claim 1.
